(19) United States
(12) Patent Application Publication
(10) Pub. No.: US 2024/0330549 A1
(43) Pub. Date: Oct. 3, 2024

(54) INTEGRATED CIRCUIT DESIGN VERIFICATION

(71) Applicant: Texas Instruments Incorporated, Dallas, TX (US)

(72) Inventors: Danyal Shamsi, Bangalore (IN); Venkata Naresh Kotikelapudi, Bangalore (IN); Venkateswaran Padmanabhan, KA (IN); Guha Lakshmanan, Bangalore (IN); Saksham Sangwan, Delhi (IN)

(21) Appl. No.: 18/191,863

(22) Filed: Mar. 28, 2023

(51) Int. Cl. G06F 30/3308

(52) U.S. Cl. CPC G06F 30/3308; G06F 2119/02

(57) ABSTRACT

In described examples, a method of testing an integrated circuit design under verification (DUV) includes selecting first and second stimulus-response data to generate a model, and adjusting model training data in response to model accuracy. The first stimulus-response data is selected from stimulus-response data for a known-good design similar to the DUV. The second stimulus-response data is selected from stimulus-response data for the DUV. The model is trained using the first and second stimulus-response data. A first correlation measure verifies model accuracy with respect to trained DUV stimulus-response data. A second correlation measure verifies model accuracy with respect to untrained DUV stimulus-response data. A fraction of trained DUV stimulus-response datasets in the second stimulus-response data is increased if the first correlation measure is greater than a first threshold, and a fraction of untrained DUV stimulus-response datasets is added if the second correlation measure is less than a second threshold.

### TECHNICAL FIELD

This application relates generally to integrated circuit (IC) design verification, and more particularly to IC design verification comparing simulated and modeled waveforms generated by a circuit in response to stimulus waveforms.

### BACKGROUND

Fabricating a physical prototype IC design can be expensive and time consuming. For example, manufacturing a corresponding mask set for use in photolithography can take over a week and cost over a million dollars. In some examples, an IC design is simulated prior to manufacture to detect design bugs and enable design iteration to improve conformance of the design to requirements of an ultimate product incorporating the design.

### SUMMARY

In described examples, a method of testing an integrated circuit design under verification (DUV) includes selecting first and second stimulus-response data to generate a model, and adjusting model training data in response to model accuracy. The first stimulus-response data is selected from stimulus-response data for a known-good design similar to the DUV. The second stimulus-response data is selected from stimulus-response data for the DUV. The model is trained using the first and second stimulus-response data. A first correlation measure verifies model accuracy with respect to trained DUV stimulus-response data. A second correlation measure verifies model accuracy with respect to untrained DUV stimulus-response data. A fraction of trained DUV stimulus-response datasets in the second stimulus data is increased if the first correlation measure is greater than a first threshold, and a fraction of untrained DUV stimulus-response datasets is added if the second correlation measure is less than a second threshold.

### BRIEF DESCRIPTION OF THE DRAWINGS

FIG. 1 is an example system including a design under verification (DUV).

FIG. 2 is an example process for detecting errors in a response signal of the DUV.

FIG. 3 is an example process that can be used to perform DUV model generation as described with respect to FIG. 2.

FIG. 4 is a table describing example models trained using data from stimulus datasets corresponding to the DUV and data from stimulus datasets corresponding to a proven design (PD).

FIG. 5 is a graph of an example actual response waveform generated by a simulation of DUV stimulus-response behavior, and of an example predicted response waveform generated by a model of DUV stimulus-response behavior, in response to an untrained DUV stimulus data.

FIG. 6 is a table of example inputs to and results of the configurable outlier detection of FIG. 2.

FIG. 7 is an example of graphs describing waveform comparison to determine DUV errors, including a first graph showing actual and predicted response waveforms, and a second graph showing a resulting maximum absolute running median filtered error (MARFE curve) and a resulting error curve.

### DETAILED DESCRIPTION

The same reference numbers or other reference designators are used in the drawings to designate the same or similar (functionally and/or structurally) features.

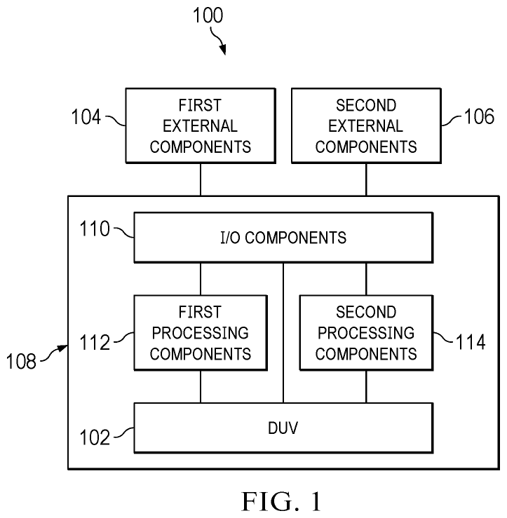

FIG. 1 is an example system 100 including a DUV 102. That is, the system 100 is an example of a system into which the DUV 102 is incorporated after the DUV 102 is verified and manufactured. The system 100 includes first external components 104, second external components 106, and an IC 108 including the DUV 102. The IC 108 also includes input/output (I/O) components 110, first processing components 112, and second processing components 114. The DUV 102 is a circuit design that is being verified (tested) to determine whether it complies with requirements—that is, whether it produces, in response to stimulus signals, response signals with waveforms that meet design requirements.

The first and second external components 104 are connected via I/O pins, pads, or other external connectors of the IC 108 to the I/O components 110. The I/O components 110 are connected via internal communication lines of the IC 108, such as a bus, to the first processing components 112. The first processing components 112 are connected via the internal communication lines to the DUV 102. The DUV 102 is connected via the internal communication lines to the second processing components 114. In some examples, the DUV 102 is connected via the internal communication lines to the I/O components 110. The second processing components 114 are connected via the internal communication lines to the I/O components 110. In some examples, the DUV 102 is, or is included in, the I/O components 110.

In some examples, the DUV 102 encompasses an IC. In some examples, such an IC includes components other than or instead of the I/O components 110, the first processing components 112, or the second processing components 114. In some examples, the DUV 102 encompasses the IC 108, including I/O and processing components 110, 112, and 114 fabricated on the IC 108. In some examples, the DUV 102 is or includes some or all of the I/O components 110, the first processing components 112, and the second processing components 114. In some examples, the DUV 102 is a circuit other than a circuit on an IC 108, such as a circuit layout on a printed circuit board (PCB).

Stimulus signals can be input signals or internal signals that, when applied to corresponding inputs or internal nodes of the DUV 102, produce a response signal. Response signals can be internal signals or output signals that the DUV 102 produces in response to stimulus signals. In an example, a source voltage to be applied to a bandgap reference is a stimulus signal applied to an internal node, and the output voltage of the bandgap reference is a response signal. Stimulus signals are selected to produce response signals of interest. A response signal of interest is a response signal that helps to determine whether the DUV 102 includes bugs causing function to deviate from design requirements, and/or where such bugs are located in the DUV 102. Bugs are also referred to herein as errors.

Testcases are sets of digital and/or analog stimulus signals designed to test signal response behavior of the DUV 102. In an example, signals are represented in testcases as samples of corresponding waveforms. Accordingly, testcases are referred to herein as stimulus datasets. An individual stimulus dataset represents one or more stimulus waveforms to be applied to respective particular inputs of the DUV 102 or a particular node in internal circuitry of the DUV 102. An internal node of the DUV 102 is, for example, an input of an internal circuit block of the DUV 102.

The DUV 102 can be verified by applying stimulus datasets to corresponding inputs or internal nodes of the DUV 102, and comparing resulting response signals of the DUV 102 to design requirements. Stimulus datasets applied to nodes of internal circuits of the DUV 102 can be used to help isolate design bugs to specific circuit blocks of the DUV 102. In some examples, stimulus datasets correspond to waveforms generated by internal circuitry of the DUV 102, the first or second external components 104 or 106, the I/O components 110, or the first or second processing components 112 or 114.

In some examples, stimulus datasets include corresponding simulated response waveforms for each of the included stimulus signals. In some examples, a stimulus dataset is a combination of stimulus signals provided to the DUV 102 across process, voltage, and temperature variations, also referred to as “corners” or “corner cases.” A process, voltage, and temperature (PVT) corner captures variation in circuit behavior across variations in IC fabrication (process), variations in a supply voltage used by the IC (voltage), and variations in a temperature at which the IC functions (temperature). Simulating, modeling, and analyzing circuit behavior across corners facilitates determining that the DUV 102 functions as designed across PVT and PVT-related variations.

In an example, the DUV 102 is a stepper control for a stepper (used in semiconductor device fabrication). In the example, a stimulus dataset includes stimulus and response signals that correspond to various PVT corners of a step control signal with a control frequency of 24 kiloHertz (kHz), a supply voltage of 24 Volts (V), a reference voltage of 1.2 V, and a selected decay scheme for current regulation. Note that the example stimulus dataset includes simulated response signals for the stimulus signals.

In some examples, a stimulus dataset includes simulated response signals corresponding both to output responsive to the stimulus signals, and internal signals of the DUV 102 responsive to the stimulus signals. In some examples, internal response signals are selected for inclusion in the stimulus dataset based on correlation with related output response signals of interest. Too correlated, or insufficiently correlated, means that an internal response signal provides insufficient additional debugging information to be worth the added computation and analysis time.

In some examples, stimulus datasets are generated by the DUV 102 designer, or provided by an intended customer or end equipment user. Stimulus datasets are constructed by applying stimulus waveforms to a simulation of the DUV 102 and logging the input and/or output response waveforms. The size of a stimulus dataset may depend on, for example, a number of corners included in the dataset and a number of samples (data points) in each stimulus signal of the dataset. The number of samples in the stimulus dataset depends on, for example, the sampling rate and the total duration of stimulation. The total duration of simulation is the period corresponding to sampling of a stimulus waveform and a corresponding response waveform. Samples taken from physical ICs can be used to form proven design stimulus datasets. In some examples, use of samples taken from simulation of a proven design facilitates analysis of internal signals of the DUV 102 using internal signals of the proven design.

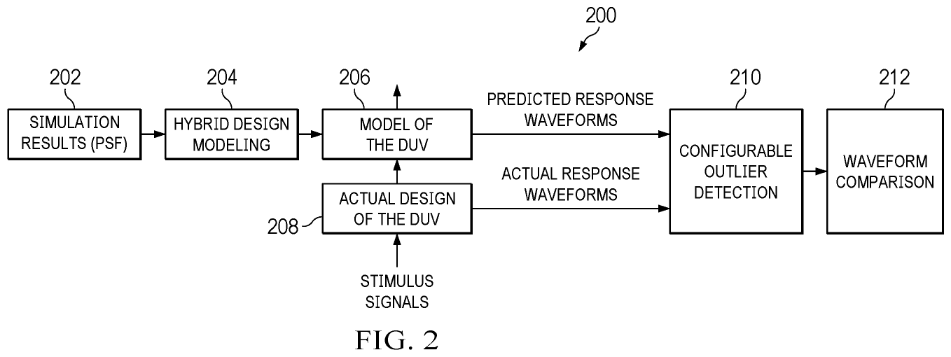

FIG. 2 is an example process 200 for detecting errors in a response signal of the DUV 102. In step 202, the DUV 102 is simulated to produce a set of response signals corresponding to a set of stimulus datasets. In some examples, a simulation applies stimulus datasets to the circuits of the DUV 102 in order to generate response waveforms corresponding to waveforms that a physical IC manufactured using the DUV 102 would produce in response to the applied stimulus datasets.

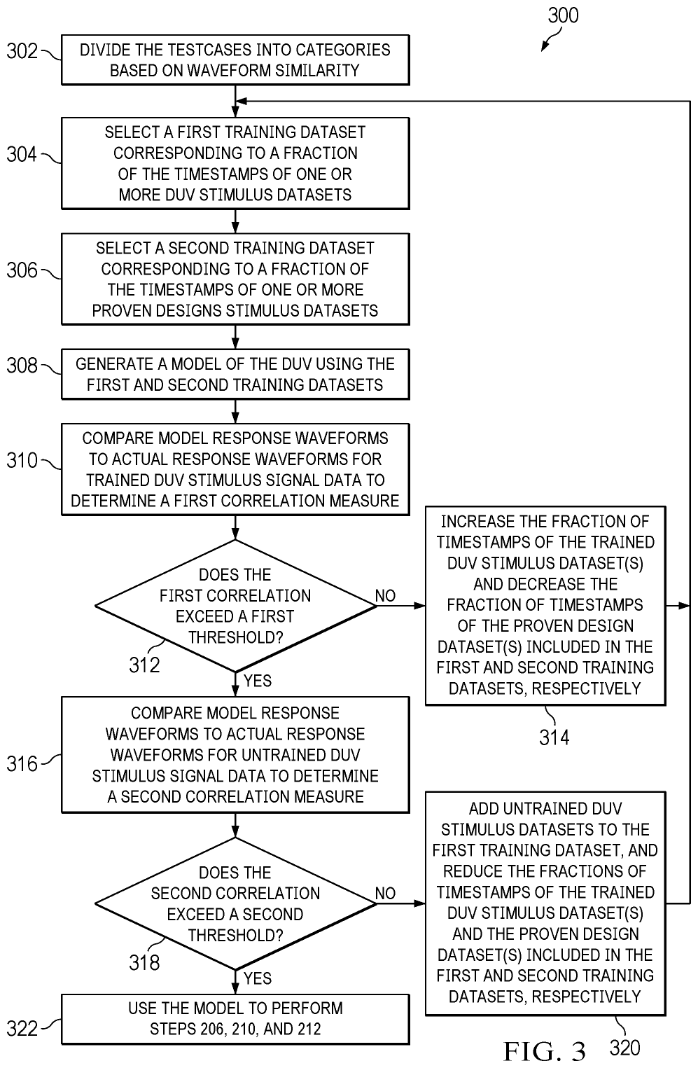

In step 204, hybrid design modelling is performed to produce a model emulating DUV 102 input signal response behavior. The model maps stimulus signals to response signals of interest. The model can be, for example, a set of decision trees generated using random forest regression, or a neural network. The model is trained using training datasets generated from a corresponding category of stimulus datasets. In some examples, stimulus datasets are categorized based on similarities of stimulus/response signal behavior and corresponding device functionality. Stimulus dataset categories are further described with respect to FIG. 3. The signal samples in the training datasets are selected from two different types of stimulus datasets, namely, a subset of the stimulus datasets developed specifically for the DUV 102, and a subset of stimulus datasets corresponding to a proven (known-good) design that is similar to the DUV 102. Similarities between a proven design and the DUV 102 used to select the proven design include, for example, overlap of design and/or function and/or signal-response behavior.

The model is intended to represent DUV 102 stimulus-response behavior that is compliant with design requirements. Simulation output waveforms are referred to herein as “actual” waveforms because, in some examples, they are generated using analysis of circuits of the DUV 102. By contrast, model output waveforms are dependent on the trained model; the model is trained using stimulus and response signals of the DUV 102 (and the proven design) and treats the circuitry of the DUV 102 as a black box. Accordingly, model output waveforms are referred to herein as “predicted” waveforms, because the model predicts DUV 102 response waveforms based on what the model learned from the training datasets. This means that, to the extent that the model accurately represents compliant device behavior, actual response waveforms can be compared to predicted response waveforms to determine a difference between actual and compliant DUV 102 stimulus-response behavior. The comparison process flags differences that exceed a threshold for at least a period corresponding to a minimum error duration as problematic, or potentially bugged. In some examples, flagged response waveform regions receive user review or further processing.

In some examples, a proven design is a design previously released for pattern-generation to be instantiated as a physical product, a design previously released to market (RTM) after being instantiated as a physical product and tested, a design that has passed verification (a previous DUV), a previously released-from-verification version of the DUV 102 (with respect to which some circuit(s) of the DUV 102 has/have been changed), or a licensed intellectual property (IP) core. In an example, a previously released-from-verification version of the DUV 102 is an 0.3 version of a design and the DUV 102 is an 0.7 version of the design. Versions 0.3 and 0.7 are used here in a similar manner to software versioning, where version 1.0 indicates a release-ready software version. Similarly, in the example, 1.0 indicates a proved good version of the design that can be released for pattern-generation in an IC fabrication process. After pattern-generation is performed, fabricated ICs are tested prior to being released to market. In some examples, the more overlap there is between the DUV 102 and a proven design, the fewer loop iterations it takes for model generation to converge to a usable model.

Example types of overlap between a proven design and the DUV 102 include similarities of circuit components and topology, nature of signal processing, signals handled by I/O interfaces, and operation in an end-application. Nature of signal processing refers to whether a signal chain of a proven design and a signal chain of the DUV 102 are similar. In an example, in an audio amplifier signal flow includes a preamplifier stage, a data converter stage, a digital signal processing (DSP) stage, another data converter stage, and another amplifier stage. Some examples of operation in an end-application include the proven design and the DUV 102 both being intended to control rotation of a motor, drive an LED, or control a sensor. In some examples, whether a proven design has sufficient overlap with the DUV 102 to provide stimulus data to a training dataset to accurately model stimulus-response behavior of the DUV 102 is determined through trial and error.

As IC signal chains increase in complexity, the complexity and time cost of developing thorough sets of stimulus datasets can increase exponentially. Designs can include multiple voltage domains, high-voltage switching, processes subject to multiple power-, emission-, or accuracy-related figures of merit, and other features requiring additional stimulus datasets corresponding to additional variables or corner cases. Using both DUV 102 and proven design stimulus dataset subsets enables the resulting model to learn product feature behavior across a variety of design variables and corner cases.

Stimulus dataset subsets corresponding to the proven design provide a rough model of DUV 102 behavior. Stimulus dataset subsets corresponding to the DUV 102 help to tune the model to improve the accuracy with which it represents compliant behavior of the DUV 102. In other words, including DUV 102 stimulus data in the training dataset corrects for differences between the DUV 102 and the proven design, such as component, connection, and layout changes, as well as stimulus and response signal differences.

Using both DUV 102 and proven design stimulus dataset subsets to generate training datasets also enables a smaller proportion of DUV 102 stimulus datasets to be used to generate training datasets, which helps to avoid overfitting in the model. Accordingly, use of both DUV 102 and proven design stimulus data to generate training datasets reduces overfitting (learned bugs in model stimulus-response behavior), and enables generation of a model that accurately represents DUV 102 response to stimulus datasets corresponding to additional variables or corner cases. This combination of advantages enables user review of response waveforms generated by the verification process to be reduced in scope. Review scope can be reduced from the full set of response waveforms generated by applying stimulus datasets to the simulated DUV 102, to a set of response waveforms (or waveform regions), within a subset of the stimulus datasets, that are flagged as potentially bugged in response to comparison of simulated and modeled response waveforms.

Further, reduction in review scope enables user time to be used more efficiently, which enables use of more DUV 102 stimulus datasets in the simulation/model comparison process. Additional stimulus datasets can be used to test responses to stimulus signals applied to more inputs or internal nodes of the DUV 102, or may correspond to signal waveforms representing more variables or corner cases applied to the same inputs or internal nodes of the DUV 102. This extra testing coverage can increase the probability of catching bugs, improving the quality of an eventual product corresponding to the DUV 102.

In step 206, stimulus signal waveforms of the DUV 102 in the modeled stimulus signal category are applied to the step 204 hybrid design model of the DUV 102 to produce a set of predicted response waveforms. In step 208, the stimulus signal waveforms used in step 206 are applied to the simulation (actual design) of the DUV 102 to produce a set of actual response waveforms.

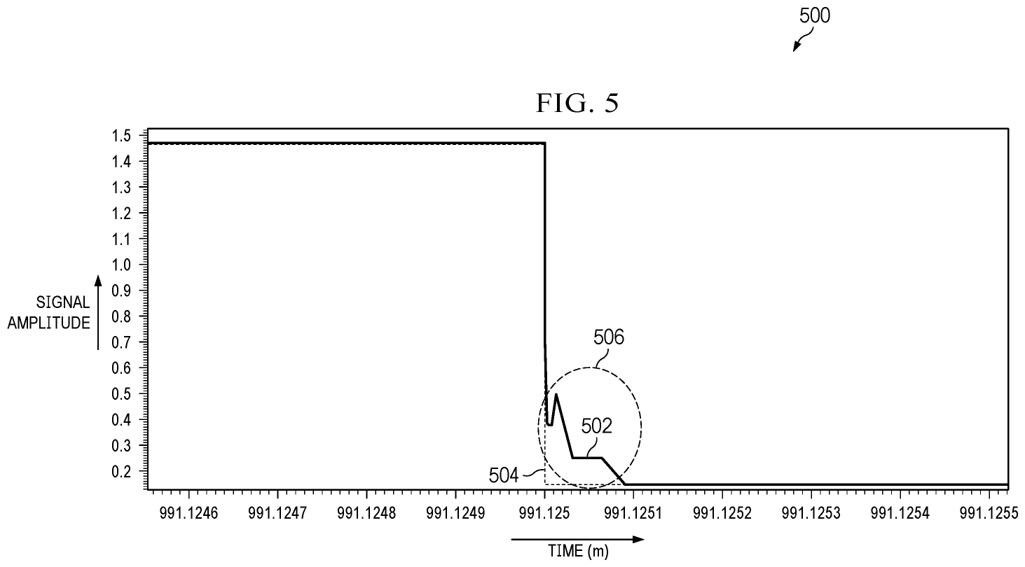

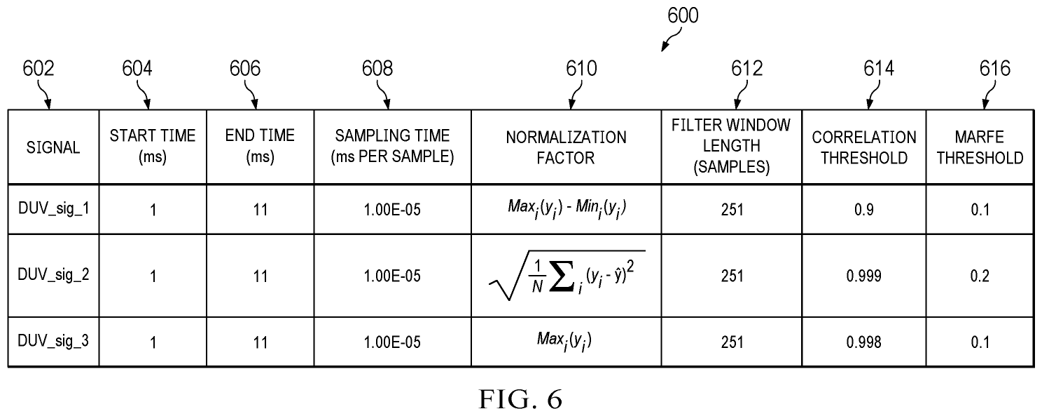

In step 210, configurable outlier detection is performed by using user input and properties of the actual response waveforms to determine thresholds and other metrics for use in detecting errors in the DUV 102. These thresholds and other metrics are further described with respect to FIGS. 5 and 6. In step 212, the actual response waveforms are compared to the predicted response waveforms, using the thresholds and other metrics determined in step 210, to detect errors in the DUV 102. For an actual response waveform and a corresponding predicted response waveform, waveform comparison determines the difference between points in the actual response waveform and corresponding points in the predicted response waveform. This difference is filtered, the filter result is normalized using the metrics determined in step 210, and the results are compared to a corresponding threshold determined in step 210.

In some examples, hybrid design modelling 204 and waveform comparison 212 are automated. In some examples, additional steps of the process 200 are automated.

FIG. 3 is an example process 300 that can be used to perform step 204 of FIG. 2. In step 302, stimulus and corresponding response signals in the stimulus datasets are divided into categories based on similarities between stimulus signal waveforms. Model generation time increases exponentially with the size of the training dataset used for model generation. Similar stimulus signals can be grouped together into a category. A model is generated using only stimulus datasets that include stimulus signals within a corresponding category, so that stimulus dataset contents not corresponding to the category are excluded from training datasets for the model. This enables a model covering a corresponding category of stimulus signals to be generated using a relatively small total training dataset size, which enables the training dataset to include stimulus data corresponding to additional variables and corner cases while avoiding a prohibitively long model generation time.

Categorization excludes signals that are too tenuously correlated to response signals of interest within a category, meaning they make relatively small contributions to the model learning DUV 102 behavior. Categorization also excludes signals that are too heavily correlated to response signals of interest within the category, meaning they can form a one-to-one function with the response and reduce model dependency on other signals that are more indicative of DUV 102 compliance with requirements. Accordingly, categorization can be done without compromising the model's ability to provide response waveforms accurately representing DUV 102 behavior for untrained or less-trained stimulus signals.

Further, categorizing stimulus signals enables model generation to be performed in parallel for the different stimulus signal categorizes. In some examples, this means that the total model generation time is a worst-case model generation time across the categories. Accordingly, model categorization can be used to reduce model generation time for models covering stimulus and response signals of interest with desired variables and corner cases. More efficient verification enables deeper search across variables and corner cases for bugs in the DUV 102. This enables a probabilistic improvement in final design quality for a given time and cost budget for verification.

In some examples, stimulus signals are grouped into categories based on whether stimulus signals are high-voltage switching signals with different off times, switching signals with different control value increment characteristics (such as step sizes, step frequencies, and total numbers of steps), and signals belonging to different voltage domains. Accordingly, in some examples, stimulus signals can be categorized in response to a type of component controlling signal behavior. In some examples, different categories correspond to different signal functions, such as device power up, fault handling, or functional operation. In an example, category A corresponds to device power up, and includes a first output voltage waveform, a first output current waveform, and a first internal signal; and category B corresponds to fault handling, and includes a second output voltage waveform, a second output current waveform, and a second internal signal. Different portions of waveforms can be categorized and modeled separately, such as portions of waveforms corresponding to device power up or steady state operation.

Stimulus signals can also be grouped into categories based on whether corresponding voltage or current waveforms are more similar to square waves or sinusoidal waves (waveform smoothness), or are otherwise similar in shape. In some examples, waveform shape similarity can be described mathematically using correlation scores between stimulus waveforms and response waveforms. For example, consider category A, with stimulus datasets x_{A-i} and response datasets y_{A-i}, and category B, with stimulus datasets x_{B-i} and response datasets y_{B-i}. x_{A-i} is a i^{th} stimulus dataset in category A, and y_{A-i} is an i^{th} response dataset generated by the DUV 102 in response to the corresponding x_{A-i}. The correlation scores Cor(x_{A-i}, y_{A-i}) will be similar for the i stimulus-response signal pairs in category A, and the correlation scores Cor(x_{B-i}, y_{B-i}) will be similar for the i stimulus-response signal pairs in category B. (In some examples, correlation scores Cor(x_{A-i}, y_{A-i}) are different from correlation scores Cor(x_{B-i}, y_{B-i}).) In some examples, this provides a way to identify stimulus signal categories agnostic of device behavior. A formula for correlation is provided by Equation 1:

$$Correlation Score = {\sum }_{i} ( ( {y}_{i} - < {y}_{i} > ) ( {y}_{i}^{*} - < {y}_{i}^{*} > ) ) / \sqrt{{\sum }_{i} {( {y}_{i} - < {y}_{i} > )}^{2} {\sum }_{i} {( {y}_{i}^{*} - < {y}_{i}^{*} > )}^{2}} \qquad Equation 1$$

In Equation 1, y; represents an i^{th} timestamp of a stimulus signal, and y* (which can be read “y star”) represents the same i^{th} timestamp of a corresponding actual response signal. Also, <yᵢ> (or <yᵢ*>) represents a mean of the signal values y (or y*) over the timestamps i. In some examples, the correlation score provided by Equation 1 captures the functional and waveform similarities between signals described above as bases for stimulus signal categorization for step 204 model generation.

Steps 304 through 322 are repeated or performed in parallel for the different categories of stimulus signals to develop corresponding category-specific models. This enables generation of different models, corresponding to the different categories, to address DUV 102 stimulus-response behavior for the various stimulus signals of interest. Steps 304 through 322 are described below with respect to a single category of stimulus signals.

Steps 304 and 306 create respective first and second training datasets, one set based on the DUV 102, the other based on a proven design. The applied training dataset is made up of the first training dataset and the second training dataset.

In step 304, a first set of training data (the first training dataset) is selected corresponding to a portion of available stimulus signals for the DUV 102 in the category being modeled. The first training dataset includes stimulus data from one or more stimulus datasets within the category being modeled. That is, all of less than all of the stimulus datasets within the category being modeled may be included. The first training dataset includes data corresponding to a randomly sampled fraction of the timestamps from within each of the included stimulus datasets. This fraction may be different for different included stimulus datasets. In some examples, timestamps are selected from within some or all of the corners (or other stimulus signal variations) in stimulus datasets included in the first training dataset. The first training dataset includes response signal data corresponding to included stimulus signal data—that is, response signal data corresponding to the stimulus signal and all included corners for all included timestamps. In some examples, the size of the selected portion of DUV 102 data is within the range 1/20^{th} to 1/10^{th} of the stimulus and response signal data in the respective included stimulus dataset. In some examples, the size of the selected portion is dependent on a design and/or function of the DUV 102. In some examples, an initial size of the selected portion of DUV 102 data is zero.

In step 306, a second set of training data (the second training dataset) is selected corresponding to a portion of available stimulus signals for a proven design in the category being modeled. In some examples, stimulus data from a single stimulus dataset of the proven design is included in the second training dataset. In some examples, more than one stimulus dataset of the proven design is included in the second training dataset. The second training dataset includes data corresponding to a randomly sampled fraction of the timestamps from within the included stimulus dataset.

In some examples, the size of the selected portion of proven design data is within the range 2/10^{th} to 3/10^{th} of the stimulus and response signal data in the included stimulus dataset. In some examples, an initial size of the selected portion is selected from within the range 2/10^{th} to 3/10^{th} of the stimulus and response signal data in the included stimulus dataset. In some examples, timestamps are selected from within some or all of the corners (or other stimulus signal variations) in stimulus datasets included in the second training dataset. The second training dataset includes response signal data corresponding to included stimulus signal data—that is, response signal data corresponding to the stimulus signal and all included corners for all included timestamps. In some examples, sizes of the first and second training datasets can vary from application to application.

In some examples, initially, a base model is generated using only the second training dataset (proven design data only). Response signal data produced by the base model is compared to actual proven design response data, similarly to steps 310 through 320, described below with respect to mixed DUV 102 and proven design data. This is done to ensure that the fraction of included proven design data is sufficient to achieve desired accuracy on proven design stimulus datasets, prior to using the proven design data to help train a model for use with DUV 102 stimulus data.

In step 308, a model of DUV 102 stimulus-response behavior is trained using the first and second training datasets. As described above, the model can be a random forest regression model. In some examples, another type of model is used, such as a neural network.

Steps 310 and 312 verify whether the model accurately predicts DUV 102 response waveforms in response to trained DUV 102 stimulus data. Trained DUV 102 stimulus data is DUV 102 stimulus data included in the first training dataset. In step 310, a first correlation measure is determined by comparing model response waveforms to actual response waveforms for the DUV 102 stimulus signal data used to train the model (corresponding to the first training dataset, generated in step 304). The first (and, below, the second) correlation measure are determined using the formula of Equation 1. To do this, the formula of Equation 1 is modified by substituting actual response signal data at timestamps i in place of stimulus signal data, and substituting predicted response signal data at timestamps i in place of actual response signal data.

In step 312, the first correlation measure is compared to a first threshold. In some examples, the first threshold is selected empirically, and different signals can have different first thresholds. In some examples, correlation thresholds used to train the model are less than one, meaning that some amount of model inaccuracy is accepted. If the first correlation measure is greater than the first threshold, the process 300 proceeds to step 316. The first correlation measure being less than the first threshold indicates possible model error, in which case the process 300 proceeds to step 314. Model error indicated by the first correlation measure being less than the first threshold corresponds to the model being underfitted with respect to stimulus-response behavior of the DUV 102.

In step 314, an amount of DUV 102 stimulus data used to create the first training dataset is increased by (1) increasing the fraction of timestamps of stimulus data included in the first training dataset from the DUV 102 stimulus dataset(s) included in the first training datasets, and (2) decreasing the fraction of timestamps of stimulus data included in the second training dataset from the proven design stimulus dataset(s) included in the second training dataset. The process 300 then goes to step 304 to iterate test set generation and model training. In some examples, randomly resampled (or otherwise different) timestamps are used to generate the training datasets in iterations of step 304. In some examples, changes in fractions of timestamps of the DUV 102 and proven design stimulus datasets are selected so that the size of the applied training dataset remains approximately constant. This means that the time taken to generate iterated models using revised training datasets is approximately constant.

Steps 316 and 318 verify whether the model accurately predicts DUV 102 response waveforms in response to untrained DUV 102 stimulus signal data. Untrained DUV 102 stimulus signal data is DUV 102 stimulus signal data in a stimulus dataset (or datasets) included in the category being modeled but not included in the first training dataset. In step 316, a second correlation measure is determined by comparing model response waveforms to actual response waveforms for untrained DUV 102 stimulus signal data. The second correlation measure is determined as described above with respect to the first correlation measure.

In step 318, the second correlation measure is compared to a second threshold. In some examples, the second threshold is selected empirically, and different signals can have different second thresholds. In some examples, the number used for the second threshold is the same as the number used for the first threshold. In some examples, a different number is used. If the second correlation measure is greater than the second threshold, the process 300 proceeds to step 322. The second correlation measure being less than the second threshold indicates possible model error, in which case the process 300 proceeds to step 320. Model error indicated by the second correlation measure being less than the second threshold corresponds to the model being underfitted with respect to untrained stimulus datasets of the DUV 102.

Note that, having reached this point, the first correlation measure is greater than the first threshold. The first correlation measure being greater than the first threshold and the second correlation measure being less than the first threshold indicates that the model may be overfitted with respect to trained stimulus datasets of the DUV 102. This means the model may have overlearned error-related behavior of the DUV 102 from the DUV 102 stimulus dataset(s) included in the first training dataset.

In step 320, a composition of DUV 102 stimulus data used to create the first training dataset is modified by (1) decreasing a fraction of timestamps of stimulus data included in the first training dataset from the DUV 102 stimulus dataset(s) included in the first training datasets, (2) adding a fraction of timestamps of stimulus data to the first training dataset from the DUV 102 stimulus dataset(s) not included in the first training datasets, and (3) decreasing the fraction of timestamps of stimulus data included in the second training dataset from the proven design stimulus dataset(s) included in the second training dataset. The process 300 then goes to step 304 to iterate test set generation and model training.

In step 322, the model is saved and used to generate predicted waveforms, as described above with respect to step 206 (see FIG. 2). These predicted waveforms are used to perform configurable outlier detection to set thresholds and other metrics in step 210, and to detect model errors in step 212.

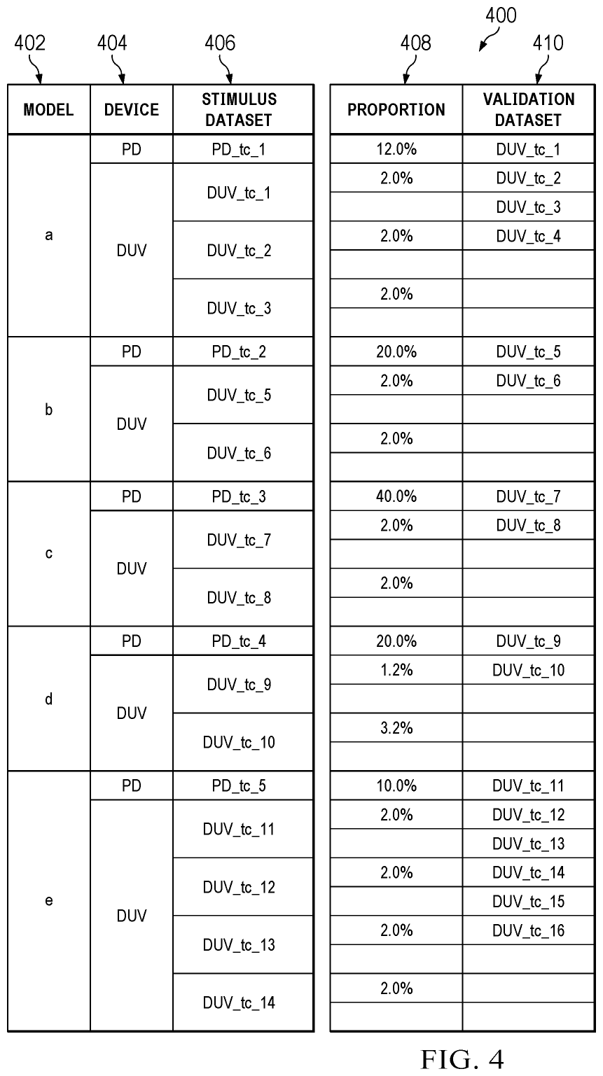

FIG. 4 is a table 400 describing example models trained using data from stimulus datasets corresponding to the DUV 102 and data from stimulus datasets corresponding to a proven design (PD). The table includes columns listing model 402 identifiers, device identifiers 404, stimulus dataset 406 identifiers for DUV 102 and proven design stimulus datasets 406 that contributed data used to train respective models 402, proportions 408 of the stimulus datasets 406 listed for a model 402 used to train the model 402, and validation datasets 410 corresponding to DUV 102 stimulus datasets 406 contributing data used to validate respective models 402.

Models 402 are lettered a, b, c, etc. In some examples, stimulus data corresponding to each stimulus signal of interest is used to train a corresponding model within a corresponding category. In some examples, one or more models are trained for each category, and one or more stimulus signals within a corresponding category are used to train multiple models within the corresponding category.

Device 404 identifiers include PD, for proven design, or DUV 102. Different models 402 correspond to different stimulus signal categories for the DUV 102. Stimulus dataset 406 identifiers are given the form here of [DUV 102 or PD]_[sd, for stimulus dataset]_[number]. Proportions 408 corresponding to the DUV 102 are X values, and proportions 408 corresponding to the PD are Y values (see FIG. 3).

Some validation datasets 410 correspond to stimulus datasets 406 used to train a model 402. Note that portions of stimulus datasets 406 used to train a corresponding model 402 are used in step 314, and portions of stimulus datasets 406 not used to train the corresponding model 402 are used in step 318. In some examples, validation datasets 410 corresponding to the model 410, and not included in the list of stimulus datasets 406 used to train the corresponding model 402, are also used in step 318.

FIG. 5 is a graph 500 of an example actual response waveform 502 generated by a simulation of DUV 102 stimulus-response behavior, and of an example predicted response waveform 504 generated by a model of DUV 102 stimulus-response behavior, in response to untrained DUV 102 stimulus data. The horizontal axis represents time, and the vertical axis represents signal amplitude. The model used to generate the predicted waveform 502 was trained as described with respect to FIGS. 3 and 4. In some examples, output response signal predicted by a model can include spikes 506 that are inaccurate predictions caused by model errors.

A metric referred to herein as maximum absolute running median filtered error (MARFE) is used to catch local outliers; enable thresholds to be assigned responsive to stimulus signal type and signal-specific characteristics; resolve erroneous short duration, high amplitude deviations (spikes) in the model from actual DUV 102 stimulus-response behavior corresponding to model inaccuracies (such as rise and fall time differences between actual and predicted response waveforms); and avoid introducing distortion into non-monotonic regions of output waveforms. This means that MARFE smooths out spikes caused by the model, without smoothing away deviations caused by errors in the DUV 102, enabling accurate, rapid determination of errors in the DUV 102. In some examples, MARFE enables bugs in DUV 102 stimulus-response behavior to be caught and isolated more quickly and reliably, while reducing false positive identification of possible bugs.

MARFE is applied to compare actual response waveforms produced by the DUV 102 to predicted response waveforms produced by a model in response to DUV 102 stimulus data for a category of stimulus signals corresponding to stimulus signals used to generate the model. In some examples, MARFE is applied to makes such comparisons for response data generated in response to all available DUV 102 stimulus data corresponding to stimulus signals within the category of signals. Analog response waveforms can be sampled for use with MARFE. A formula for determining MARFE is given by Equation 2:

$$MARFE = \frac{{Max}_{i} \vert F ( {y}_{i} - {\hat{y}}_{i} , W ) \vert}{Normalizing Factor} \qquad Equation 2$$

In Equation 2, F(y, W) is a running median filter applied to actual response signal y and a corresponding predicted response signal y (which can be read “y hat”). F(y, W) operates on a filter window of duration W, yᵢ represents samples of the actual response waveform with timestamps i within the window, and ŷᵢ represents samples of the predicted response waveform with timestamps i within the window. The filter window is a time span measured in samples. The start and end timestamps of the filter window are successively iterated so that the filter acts on the timestamps i (in some examples, all timestamps i) within the actual and predicted response datasets corresponding to the signals y and ŷ. Accordingly, F(yᵢ−ŷᵢ, W) filters a windowed error corresponding to a sample-by-sample difference between an actual response waveform and a corresponding predicted response waveform.

The normalization factor is selected in response to response signal behavior—for example, fast switching signals or slowly ramping signals, accurate reference signals, signals that are switched between a high rail voltage and a low rail voltage (rail-to-rail switching signals), or constant value signals (such as a constant current)—to enable comparison of MARFE to a threshold. MARFE normalization factors are further described with respect to FIG. 6. The Maxᵢ| | function returns the maximum absolute value of the filter result across all timestamps i of the set of stimulus data corresponding to signal y applied to the filter. Accordingly, this maximum is a maximum absolute value of a filtered actual versus predicted response signal error. This maximum is normalized to produce MARFE for the corresponding stimulus signal. If MARFE is greater than a threshold corresponding to the stimulus signal, an possible error in DUV 102 stimulus-response behavior is flagged for the corresponding window and/or all or part of the bugged stimulus signal.

Example operation of a running median filter F (A, W) is now described. In the example, an array A has elements {1, 2, 3, 100, 4, 5, 6}, the filtering window length is 3, and F (A, W) is determined. Some results, to demonstrate: the median of the window {1, 2, 3} is 2, the median of the window {2, 3, 100} is 3, and the median of the window {3, 100, 4} is 4. In other words, the k^{th} element in the result equals Median(A(k−1), A(k), A(k+1)), where k is an index of array A and A(k) is the k^{th} element in A. Accordingly, F (A, W)={1, 2, 3, 4, 5, 5, 6}, and Max(F(A,W))=6. The first and last entries in the example filter result are determined by implementation details in the example filter relating to requiring that an input array size equals an output array size. In some examples, a filter does not require an output array to be the same size as the input array, or handles initial or end entries differently.

Different stimulus signals—and accordingly, different stimulus datasets—can have different corresponding minimum durations of bugs to be detected. In some examples, a minimum duration of bugs to be detected is selected in response to a minimum bug duration that will adversely affect DUV 102 operation, minimum detectable bug duration, and design goals for a design iteration. Similar considerations can be used to select a minimum amplitude of bugs to be detected, which is further described with respect to Equation 7, below. In some examples, later design iterations experience, and corresponding verification processes target, shorter-duration and/or smaller-amplitude bugs.

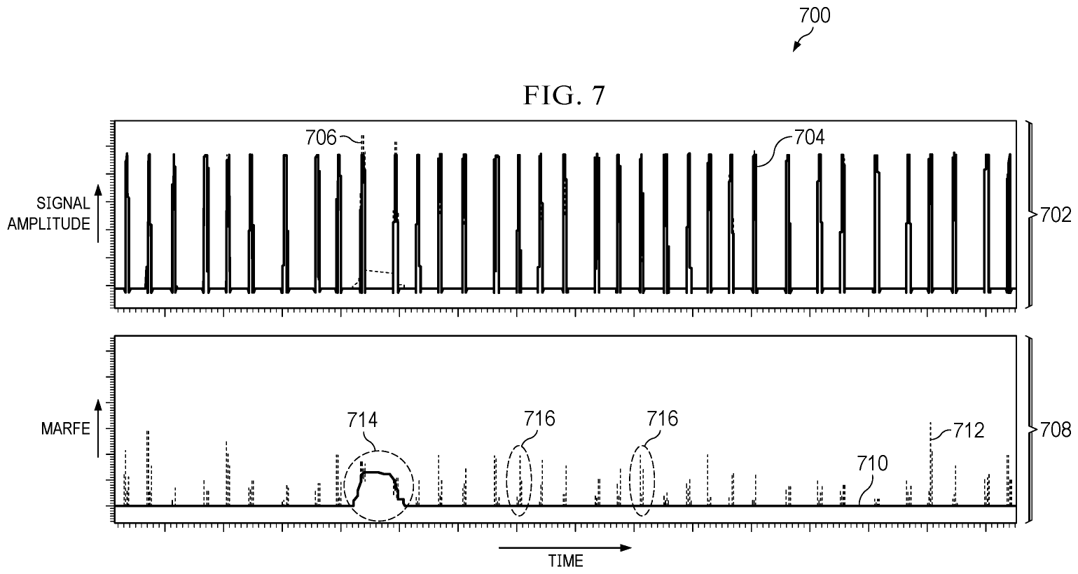

Filter window lengths 612 (see FIG. 6) are selected in response to minimum durations of bugs to be detected for corresponding stimulus signals. In some examples, shorter filter window lengths 612 correspond to an increase in false positive identifications of DUV 102 errors, and longer filter window 612 durations correspond to an increase in failures to flag DUV 102 errors. Using minimum bug durations to determine filter window lengths 612 enables selecting filter window lengths 612 that have greater duration than spikes 506 caused by model error and spikes 714 (see FIG. 7) in an error curve 712 corresponding to a difference between the actual and predicted response waveforms 704 and 706, avoiding false positives. This also enables filter window lengths 612 to be selected to be sufficiently brief to avoid distorting response signal waveform portions corresponding to DUV 102 errors, which can introduce false negatives.

FIG. 6 is a table 600 of example inputs to and results of the step 210 configurable outlier detection of FIG. 2. The table 600 includes columns listing signals 602, start times 604 of waveforms to be compared, end times 606 of waveforms to compared, sampling times 608 (the interval between samples taken of corresponding waveforms), normalization factors 610, filter window lengths 612, correlation thresholds 614, and MARFE thresholds 616. In the illustrated example, start times 604 and end times 606 are measured in milliseconds (ms), and sampling times 608 are measured in milliseconds per sample. Filter window lengths 612 are measured in samples to facilitate use of MARFE. As described above, MARFE is determined in response to sample values. Units used in the table 600 are selected to correspond to units applicable to simulated stimulus datasets.

In some examples, the information in the table 600 is provided by a user. In some examples, the normalization factors 610, filtering window lengths 612, and MARFE thresholds 616 are computed or otherwise decided in response to a nature of a corresponding response signal, a minimum duration of bugs to be detected, and a maximum allowed amplitude deviation between actual and predicted response waveforms.

In some examples, the simulation produces non-uniformly sampled waveforms, such as waveforms sampled with sampling times varying between 1E-18 seconds and 1E-6 seconds. Actual and predicted response waveforms can be resampled prior to filtering to enable the windowed filter of MARFE to be applied uniformly across response waveform regions. For example, filter window lengths 612 are measured in samples. Resampling makes the amount of time corresponding to a number of samples uniform. Sampling times 608 are selected to be short enough to avoid sampling and filtering taking too long, and short enough to avoid aliasing affecting results. Aliasing is distortion, such as false frequency components, introduced by low-rate sampling. Sampling times 608 can be selected in response to a shortest switching cycle period (a shortest on-off cycle). For example, a sampling time 608 can be selected as 1/800^{th} of a minimum switching cycle.

In some examples, designs include a wide variety of signal types with different waveform characteristics, such as high or low voltage signals, fast or slow switching signals, precisely generated analog voltages or currents, and periodic, slowly ramping signals such as inductor current and capacitor voltage. To address different waveform characteristics, different normalization factors 610 are used to normalize the MARFE for different types of signals. Normalization factors are independent of predicted waveforms. Different normalization factors correspond to different types of response signal behavior, and response signals are categorized accordingly to determine which normalization factor to use to apply MARFE to which response signal.

Categorizing response signals enables signal-specific thresholds, determined in response to signal nature, to be determined in step 210. In some examples, similar thresholds can be applied to all available stimulus data corresponding to all stimulus signals in a category. In some examples, categorizing stimulus signals enables signal-specific thresholds to be tailored to be highly sensitive to bugged signals, reducing false negatives (missed bugs), while also reducing spurious flagging of potentially bugged signals, reducing false positives. This enables faster and more effective bug isolation and detection. In some examples, this enables manufacture of products corresponding to the DUV 102 with fewer bugs.

In an example, the category A and B output voltage waveforms described in the example provided in the description of FIG. 3 are fast switching voltage waveforms; the category A and B output current waveforms are slow ramping current waveforms; and the category A and B internal signals are accurate analog references (constant waveforms). Accordingly, the normalization factor of Equation 3 is used to apply MARFE to the output voltage waveforms, the normalization factor of Equation 4 is used to apply MARFE to the output current waveforms, and the normalization factor of Equation 5 is used to apply MARFE to the internal signals. This example helps to demonstrate that step 210 categorization for outlier detection is different from step 204 categorization for model generation. In some examples, in step 204 categorization, different stimulus signals in a stimulus dataset share the same category for modeling purposes, while in step 210 categorization, different response signals in a stimulus dataset may be in different categories for purposes of normalization factor selection.

Three different types of response signals, corresponding to three different normalization factors, are represented in the table 600. Other types of response signals may have different waveform behaviors, and may accordingly correspond to different normalization factors. DUV_sig_1 is a signal controlled by a switch to alternatingly correspond to a high voltage rail or a low voltage rail, and a corresponding normalization factor 610 is provided in Equation 3. DUV_sig_2 is a slowly ramping current signal, and a corresponding normalization factor 610 is provided in Equation 4. DUV_sig_3 is an accurate analog voltage reference, such as a bandgap reference, and a corresponding normalization factor 610 is provided in Equation 5. A first normalization factor 610, corresponding to DUV_sig_1, is given in Equation 3:

$${Max}_{i} ( {y}_{i} ) - {Min}_{i} ( {y}_{i} ) \qquad Equation 3$$

The Equation 3 normalization factor 610 describes a range between a maximum sample and a minimum sample of the actual (simulated) response waveform over the time range of the samples. In some examples, the Equation 3 normalization factor 610 is used for signals that have a constant maximum and a constant minimum. An example of this type of signal is a high-frequency switching voltage that is coupled to a high voltage rail during a first switching phase, and is coupled to a low voltage rail during a second switching phase. A second normalization factor 610 is given in Equation 4, in which y (which can be read “y bar”) is the average of the samples of the actual waveform over all samples corresponding to a particular signal, and N is the number of samples:

$$\sqrt{\frac{1}{N} {\sum }_{i} {( {y}_{i} - \overline{y} )}^{2}} \qquad Equation 4$$

The Equation 4 normalization factor 610 describes a standard deviation of the actual waveform of a particular signal over all timestamps i. In an example, the actual waveform is an inductor current waveform centered about zero Amperes, and Equation 4 represents the RMS (root mean square) value of the signal. In some examples, the Equation 4 normalization factor 610 is used for signals in which glitches can change the maximum or minimum values of the signal. Examples of this type of signal include a slowly ramping inductor current, and a voltage reference for which the relationship between peak current and the reference voltage is linear. A third normalization factor 610 is given in Equation 5:

$${Max}_{i} ( {y}_{i} ) \qquad Equation 5$$

The Equation 5 normalization factor 610 describes a maximum value within the window of samples of the actual waveform. In some examples, the Equation 5 normalization factor 610 is used for static or constant signals, such as a bandgap reference.

MARFE results are compared to corresponding MARFE thresholds 616 to determine whether DUV 102 output indicates potential errors. As described above with respect to FIG. 5, MARFE filter windows 612 are selected in response to a minimum duration of errors the waveform comparison 212 is intended to detect so that spikes caused by model errors will be reduced or eliminated, without hiding DUV 102 errors. Minimum duration of errors to be detected (not shown) with respect to a corresponding stimulus signal is an example metric entered by a user. The filter window length 612 operates on and is measured in a number of samples. Accordingly, the minimum duration of potential bugs for a particular stimulus signal to be flagged using MARFE is normalized to the correct units: samples. In an example, minimum durations of bugs to be detected are entered in milliseconds, and are normalized by corresponding sampling times 608, which are measured in milliseconds per sample. The resulting normalized minimum bug duration is measured in samples.

Empirical analysis shows that in some examples, a filter window 612 length that is between one fifth and one fourth of the minimum duration of DUV 102 errors of interest facilitates accurately locating bugs in DUV 102 response waveforms. Accordingly, a formula for determining MARFE filter window lengths 612 is given by Equation 6, where T_{b} is the minimum duration of DUV 102 bugs to be caught, and Tₛ is the sampling time 608:

$$0.2 \times \frac{{T}_{b}}{{T}_{s}} \leq Filter Window Length \leq 0.25 \times {T}_{b} / {T}_{s} \qquad Equation 6$$

In some examples, correlation thresholds 614 are chosen empirically, in response to observation of DUV 102 input signal response during the design iteration process. Individual MARFE thresholds 616 are chosen for use with respect to a corresponding stimulus signal of interest, which is a particular input or internal signal of the DUV 102. This enables the MARFE threshold 616 to be selected as a minimum value, to reduce unflagged bugged portions of response waveforms. Accordingly, MARFE thresholds 616 are chosen in response to a minimum error magnitude that the waveform comparison 212 is intended to detect, and a maximum normalization factor across the available stimulus datasets that include the corresponding stimulus signal of interest. Accordingly, a formula for determining MARFE thresholds 616 is given by Equation 7:

$$MARFE Threshold = \frac{Min ( Error Magnitude )}{Max ( Normalizing Factor )} \qquad Equation 7$$

Use of MARFE with appropriate normalization factors 612, filter window lengths 614, and MARFE thresholds 616—determined in the step 210 configurable outlier detection-enables step 212 waveform comparison to be performed more accurately. This means that use of MARFE results in fewer incorrectly flagged potential bugs in response to stimulus dataset portions for which DUV 102 stimulus-response behavior is compliant (false positives), and fewer missed/unflagged bugs in response to stimulus dataset portions for which DUV 102 stimulus-response behavior contains bugs (false negatives). In some examples, this reduces review effort, enabling bugs to be caught and resolved more quickly; and results in fewer bugs in iterated DUV 102 designs, leading to fewer bugs in a physically instantiated final product corresponding to the DUV 102.

FIG. 7 is an example of graphs 700 describing waveform comparison to determine DUV 102 errors, including a first graph 702 showing an actual response waveform 704 and a corresponding predicted response waveform 706, and a second graph 708 showing a resulting MARFE curve 710 and a resulting error curve 712. The error curve 712 shows the sample-by-sample difference between the actual response waveform 704 and the predicted response waveform 706. In both graphs 702 and 708, the horizontal axis is time. In the first graph 702, the vertical axis is signal amplitude, and in the second graph 708, the vertical axis is unitless MARFE (a filtered error value). Locations where the actual and predicted waveforms 704 and 706 overlap correlate to (but do not necessarily indicate) design features, that is, intended DUV 102 output. Locations where the actual and predicted response waveforms 704 and 706 do not overlap correlate to (but do not necessarily indicate) DUV 102 errors. The MARFE curve 710 indicates a deviation 714 between the actual and predicted response waveforms 704 and 706. If this deviation 714 exceeds a corresponding MARFE threshold 616, the deviation 714 indicates a possible DUV 102 error and is flagged for further review.

By contrast, the error curve 712 shows multiple spikes 716 in addition to the deviation 714. In the example shown, the spikes 716 are caused by modeling inaccuracies, such as rise and fall time differences between the actual response waveform 704 and the corresponding predicted response waveform 706. Spikes 716 have durations responsive to the difference in rise or fall time between the actual and predicted response waveforms 704 and 706. MARFE filters out, and avoids flagging, these short-duration spikes 716

Modifications are possible in the described embodiments, and other embodiments are possible, within the scope of the claims.

In some examples, a fraction of included proven design data or a total size of the applied training dataset can be increased if it is determined during iteration of the process 300 that the fraction of included proven design data is too small to generate a useful baseline model enabling representation of a desired range of DUV 102 stimulus-response behavior.

In some examples, during model generation, an amount of included DUV 102 stimulus signal data is increased or decreased by adding or removing (respectively) one or more stimulus datasets for the DUV 102 in the category being modeled to or from the first training dataset. In some examples, an amount of included proven design stimulus signal data is increased or decreased by adding or removing (respectively) one or more stimulus datasets for the proven design in the category being modeled to or from the second training dataset.

In some examples, a fraction of proven design stimulus signal data included in the second training dataset is not modified, or is modified in a manner other than described above, when the fraction or composition of DUV 102 stimulus signal data included in the first training dataset is changed.

In some examples, information in the table 600 is determined by automated analysis of response signals.

In some examples, the DUV 102 is a stepper motor driver and the first and second external components 104 and 106 include a stepper motor driven by the DUV 102.

In some examples, the DUV 102 is a power switching circuit, a brushed direct current (BDC) motor driver circuit, a solenoid driver circuit, or a light emitting diode (LED) driver circuit.

In some examples, stimulus signals are analog signals or digital signals.

In some examples, methods and/or systems disclosed herein are used with various circuit topologies, end applications, and/or stimulus and response signal types.

In some examples, a proportion of DUV 102 stimulus data used in the first training dataset is used that is larger or smaller than the 1/20^{th} to 1/10^{th} range.

In some examples, a proportion of proven design stimulus data used in the second training dataset is used that is larger or smaller than the 2/10^{th} to 3/10^{th} range.

In some examples, if the model is determined to be overfitted, then untrained DUV 102 stimulus data is added to the first training dataset, but trained DUV 102 stimulus data is not removed from the first training dataset.

What is claimed is:

1. A method of testing an integrated circuit design under verification (DUV), the method comprising:
a) selecting a first portion of stimulus-response data corresponding to one or more stimulus signals for a known-good design that is similar to the DUV, the first portion being a first fraction of stimulus-response data corresponding to the stimulus signals of the known-good design;
b) selecting a second portion of stimulus-response data corresponding to one or more stimulus signals for the DUV, the second portion being a second fraction of stimulus-response data corresponding to the stimulus signals of the DUV, so that a third portion of stimulus-response data corresponds to stimulus signals of the DUV not included in the second portion;
c) generating a model of stimulus-response behavior of the DUV using the first portion and the second portion;
d) determining a first correlation measure in response to the model, the DUV, and the second portion;
e) determining a second correlation measure in response to the model, the DUV, and the third portion;
f) increasing the second fraction in response to the first correlation measure being less than the first threshold; or
g) adding a third fraction of the third portion of stimulus data to the second portion in response to the second correlation measure being less than the second threshold; and
h) repeating steps a) through g) in response to the first correlation measure being less than the first threshold or the second correlation measure being less than the second threshold.

2. The method of claim 1,
wherein the correlation measure is determined as:
$$Correlation Score = {\sum }_{i} ( ( {y}_{i} - < {y}_{i} > ) ( {y}_{i}^{*} - < {y}_{i}^{*} > ) ) / \sqrt{{\sum }_{i} {( {y}_{i} - < {y}_{i} > )}^{2} {\sum }_{i} {( {y}_{i}^{*} - < {y}_{i}^{*} > )}^{2}} ;$$
wherein y; represents an ith timestamp of a stimulus signal y, y* represents the same ith timestamp of a corresponding actual response signal, <yᵢ> represents a mean of the stimulus signal values y over the timestamps i, and <yᵢ*> represents a mean of the actual response signal values y* over the timestamps i.

3. The method of claim 1,
wherein increasing or reducing the first fraction or the second fraction corresponds to increasing or reducing a fraction of timestamps of stimulus signals included in the first or second portion, respectively.

4. The method of claim 1, wherein step f) reduces the first fraction in response to the first correlation measure being less than the first threshold, and step g) reduces the first fraction in response to the second correlation measure being less than the second threshold.

5. The method of claim 1,
further comprising, prior to steps a) through g), categorizing the stimulus signals for the known-good designs and the stimulus signals for the DUV into multiple categories based on similarities between the stimulus signals with respect to one or more of: related device behavior, waveform smoothness, or similarity in correlation scores comparing stimulus signal waveforms to corresponding response signal waveforms;
wherein steps a) through h) are performed separately for the different categories.

6. The method of claim 1, further comprising, in response to the first correlation measure being greater than the first threshold and the second correlation measure being greater than the second threshold:
i) determining error measurements for respective actual response signals corresponding to the stimulus signals of the DUV, the error measurements determined in response to a difference between actual response signal waveforms generated by applying the stimulus signals for the DUV to a simulation of the DUV, and predicted response signal waveforms generated by applying the stimulus signals for the DUV to the model; and
j) flagging as potentially bugged ones of the actual response signals for which a corresponding one of the error measurements is greater than a third threshold.

7. The method of claim 6, wherein the third threshold is determined in response to a response signal-specific minimum error magnitude to be detected.

8. The method of claim 1,
wherein the reducing in response to the first correlation measure being less than the first threshold compensates for an underfitting of the model to the DUV stimulus data corresponding to the stimulus signals for the DUV; and
wherein the reducing in response to the second correlation measure being less than the second threshold compensates for an overfitting of the model to the DUV stimulus data corresponding to the stimulus signals for the DUV.

9. The method of claim 1, further comprising, in response to the first correlation measure being greater than the first threshold and the second correlation measure being greater than the second threshold, using the model to locate the bug in the DUV.

10. The method of claim 1, wherein step g) includes reducing the second fraction in response to the second correlation measure being less than the second threshold.

11. The method of claim 1, wherein the known-good design is one of: a design corresponding to a product previously released to market, a previously verified design corresponding to a previous design iteration of the DUV, or a design provided by a third party.

12. A method of testing an integrated circuit design under verification (DUV), the method comprising:
sampling actual response waveforms produced by simulating the DUV to produce a first set of samples xᵢ;
sampling predicted response waveforms produced by a model of the DUV to produce a second set of samples yᵢ, where i is a number identifying a timestamp in each of the first and second sets of samples;
filtering a difference between the first and second sets of samples to determine a maximum absolute running median filtered error z, where Maxᵢ determines a maximum across the timestamps i, W is a filter window length, NF is a normalization factor, and F(samples, W) performs a running median filter on the samples:
$$z = \frac{{Max}_{i} \vert F ( {x}_{i} - {y}_{i} , W ) \vert}{NF} ;$$
and
comparing z to a threshold, so that z being greater than the threshold indicates a possible bug in the DUV.

13. The method of claim 12, wherein the sampling actual response waveforms and the sampling predicted response waveforms are performed using a same, uniform sample rate that is a sufficiently high rate to avoid aliasing.

14. The method of claim 12, wherein the filter window length is selected in response to a minimum duration of an error in a waveform to indicate the presence of a bug in the DUV, and a time between adjacent samples in xᵢ or between adjacent samples in yᵢ.

15. The method of claim 12, wherein the normalization factor is one of Maxᵢ(xᵢ)−Minᵢ(xᵢ),
$$\sqrt{\frac{1}{N} {\sum }_{i} {( {x}_{i} - {y}_{i} )}^{2}} ,$$
or Maxᵢ(xᵢ), where Min; indicates a minimum across the timestamps i.

16. The method of claim 12, wherein the threshold equals a minimum magnitude of an error in a waveform to indicate the presence of a bug in the DUV, divided by a maximum normalization factor.

17. A method of testing an integrated circuit design under verification (DUV), the method comprising:
categorizing stimulus signal datasets of the DUV into categories in response to one or more of: related device behavior, waveform smoothness, or similarity in correlation scores comparing stimulus signals to corresponding response signals;
generating multiple models, different ones of the models generated using stimulus data corresponding to stimulus signal datasets in corresponding ones of the categories;
generating actual response data by applying stimulus signals of the corresponding stimulus signal datasets of the DUV to a simulation of the DUV, and generating predicted response data by applying the stimulus signals of the DUV in respective ones of the categories to ones of the models generated using respectively categorized stimulus data;
generating multiple error measurements, different ones of the error measurements corresponding to different ones of the stimulus signals, the corresponding error measurement generated in response to a difference between actual response data of the corresponding stimulus signal, and predicted response data of the corresponding stimulus signal;
flagging as potentially bugged actual response data for which a corresponding one of the error measurements is greater than a threshold.

18. The method of claim 17,
wherein the categories are first categories;
further comprising categorizing response signals into second categories in response to response signal behavior.

19. The method of claim 18, wherein the generating error measurements normalizes ones of the error measurements corresponding to stimulus signals in same ones of the categories using same normalization factors.

20. The method of claim 18, wherein different error thresholds are selected for different response signals in response to corresponding response signal-specific minimum error magnitudes to be detected.
